(19) United States
(12) Patent Application Publication
(10) Pub. No.: US 2026/0329701 A1
(43) Pub. Date: Oct. 22, 2026

(54) SYSTEM AND METHOD FOR RESIZING STORAGE VOLUMES ON A BACKUP RESTORE

(71) Applicant: Eon IO, Ltd., Tel Aviv (IL)

(72) Inventors: Assaf NATANZON, Tel Aviv (IL); Dmitry KUZNETSOV, Tel Aviv Yafo (IL); Haim BEN-SHIMOL, Kfar Saba (IL)

(73) Assignee: Eon IO, Ltd., Tel Aviv (IL)

(21) Appl. No.: 19/186,139

(22) Filed: Apr. 22, 2025

(51) Int. Cl. G06F 11/14

(52) U.S. Cl. CPC G06F 11/1469

(57) ABSTRACT

A system and method for resizing cloud volumes on a backup restore are presented. The method includes receiving a command to restore a cloud volume, the command is being received during a restore of the backup volume, wherein backup volume provides a backup of the cloud volume; computing a target volume size for a restored cloud volume, wherein the target volume size is computed based on sizing information gathered over time during the backup of the cloud volume; determining a structure type of the cloud volume; and restoring the backup volume to the restored cloud volume based on the target volume size and the determined structure type, wherein the restored cloud volume contains same files and structure as the cloud volume, and wherein a size of the cloud restored volume is different than a size of the cloud volume as originally created.

### TECHNICAL FIELD

The present disclosure relates generally to digital backup in computing environments and, more particularly, to techniques for managing storage volumes in cloud computing environments.

### BACKGROUND

Cloud storage volumes (“cloud volumes”) are virtualized block-level storage devices used in cloud computing environments, offering persistent, scalable, and high-performance storage for virtual machines. Key attributes include durability, detachability, encryption, and performance tiers (e.g., SSD vs. HDD). These volumes require a file system, such as ext4, XFS (Linux), or NTFS (Windows), to organize and access data and can be formatted and mounted similarly to physical disks. Examples include AWS Elastic Block Store (EBS), Azure Managed Disks, and Google Persistent Disks, each offering volume types tailored for various workloads, such as databases, applications, or backups. Managed file systems, such as Amazon EFS or Azure Files, also provide shared access across instances.

In many computing environments, cloud volumes are frequently created, replicated, and moved across multiple virtual machines, cloud accounts, and regions. Furthermore, over time, the size of cloud volumes can be adjusted, either expanded or reduced. The management of cloud volumes is typically provided by a cloud orchestrator provide by the cloud provider. For example, in AWS®, the management of cloud volumes is provided by a logical volume manager (LVM). The LVM is a device mapper framework that provides logical volume management for the Linux kernel. The LVM enables flexible disk management by abstracting physical storage devices and presenting them as logical volumes. This abstraction layer enables administrators to manage disk storage more efficiently and dynamically.

Cloud volumes, as discussed herein, refer to logical volumes. A logical volume is a virtual partition created from the storage pool provided by a volume group. A volume group is a collection of physical volumes. A physical volume is the actual physical storage device(s), such as hard drives or partitions, used by LVM. A physical volume can be initialized for use by LVM using a specific command.

Logic volumes can be resized, moved, and managed independently of the underlying physical storage. Logical volumes are created and managed using, for example, the LVM.

The operations for changing the size of a cloud volume include volume expansion and volume shrinking. Volume expansion refers to the process of increasing the size of an existing EBS volume. This is a common operation when an application's storage requirements grow over time. Most cloud providers make it straightforward to expand cloud volumes without downtime, ensuring that applications can continue to run smoothly while the storage capacity is increased.

Volume shrinking refers to the process of reducing the size of an existing cloud volume. Unlike volume expansion, shrinking cloud volumes are not directly supported by cloud providers. This is because reducing the size of a volume may lead to data loss if not handled carefully. Volume shrinking typically involves creating a new, smaller volume and copying data from the original volume to the new one. As such, this operation can be complex and may require substantial downtime.

Further, volume shrinking presents several challenges that stem from its inherently complex and manual nature. The process typically requires creating snapshots, provisioning and attaching new volumes, copying data, updating mount points, and ultimately detaching and deleting the original volume. Each step must be executed with precision to avoid data loss, which makes maintaining data integrity a significant concern. Additionally, this multi-step workflow often introduces operational complexity and may necessitate system downtime, particularly during data transfer and volume switching, making it difficult to perform at scale or in high-availability environments.

Currently, there are no efficient solutions that allow cloud volume resizing, particularly in providing such operations by a cloud backup system.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving a command to restore a cloud volume, the command is received during a restore of the backup volume, where backup volume provides a backup of the cloud volume. The method may also include computing a target volume size for a restored cloud volume, where the target volume size is computed based on sizing information gathered over time during the backup of the cloud volume. The method may furthermore include determining a structure type of the cloud volume; and restoring the backup volume to the restored cloud volume based on the target volume size and the determined structure type, where the restored cloud volume contains same files and structure as the cloud volume, and where a size of the cloud restored volume is different than a size of the cloud volume as originally created. Other embodiments of this aspect include corresponding computer systems, apparatus, and computer programs recorded on one or more computer storage devices, each configured to perform the actions of the methods.

Implementations may include one or more of the following features. The method where computing the target volume size may include: retrieving the sizing information from a metadata of the backup volume; and applying a target function on the sizing information to compute the target volume size. The method where the target function is any one of: a simple decay function, a statistical function, and a linear function. The method where determining the structure type of the cloud volume further may include: analyzing structure information gathered during backup to determine filesystem options, management options, binary options, and boot options of the cloud volume. The method where the structure type of the cloud volume is a binary volume, and where restoring the backup volume further may include: determining if the last blocks of the backup volume have been allocated; creating the restored cloud volume; setting of the restored cloud volume to a size set to the target volume size; and restoring at a block-level all allocated blocks to the restored volume. The method where the structure type of the cloud volume is an unbootable volume with a filesystem, and where restoring the backup volume further may include: creating the restored cloud volume; setting of the restored volume to a size set to the target volume size; installing a new filesystem on the restored volume, where a type of the new filesystem is a type of filesystem installed on the cloud volume; and restoring files from the backup volume at a file-level to the new filesystem. The method may include: restoring access control lists of the files restored to the new filesystem. The method where the cloud volume is bootable, and where restoring the backup volume further may include: creating the restored volume as a bootable volume; setting of the restored volume to a size set to the target volume size; installing a new filesystem on the restored volume, where a type of the new filesystem is a type of filesystem installed on the cloud volume; restoring boot data blocks at boot sectors of the restored volume; and restoring files at the a file-level after restoring the boot data blocks, where the size of the restored files is less than the target volume size. The method where the cloud volume is managed, and where restoring the cloud volume further may include: creating a new restored volume based on a configuration retrieved from a volume manager; setting of the restored volume to a size set to the target volume size; installing a new filesystem on the restored volume, where a type of the new filesystem is a type of a filesystem installed on the cloud volume; and restoring files from the backup volume at a file-level to the new filesystem. The method where the cloud volume, the backup volume, and the restored backup are deployed in one or more cloud computing platforms. Implementations of the described techniques may include hardware, a method or process, or a computer tangible medium.

In one general aspect, a non-transitory computer-readable medium may include one or more instructions that, when executed by one or more processors of a device, cause the device to: receive a command to restore a cloud volume, the command is being received during a restore of the backup volume, where backup volume provides a backup of the cloud volume; compute a target volume size for a restored cloud volume, where the target volume size is computed based on sizing information gathered over time during the backup of the cloud volume; determine a structure type of the cloud volume; and restore the backup volume to the restored cloud volume based on the target volume size and the determined structure type, where the restored cloud volume contains same files and structure as the cloud volume, and where a size of the cloud restored volume is different than a size of the cloud volume as originally created. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: receive a command to restore a cloud volume, the command is being received during a restore of the backup volume, where the backup volume provides a backup of the cloud volume. The system may in addition compute a target volume size for a restored cloud volume, where the target volume size is computed based on sizing information gathered over time during the backup of the cloud volume. The system may moreover determine a structure type of the cloud volume. The system may also restore the backup volume to the restored cloud volume based on the target volume size and the determined structure type, where the restored cloud volume contains same files and structure as the cloud volume, and where a size of the cloud restored volume is different than a size of the cloud volume as originally created. Other embodiments of this aspect include corresponding computer systems, apparatus, and computer programs recorded on one or more computer storage devices, each configured to perform the actions of the methods.

Implementations may include one or more of the following features. The system where the memory contains further instructions that, when executed by the processing circuitry for computing the target volume size, further configure the system to: retrieve the sizing information from a metadata of the backup volume; and apply a target function on the sizing information to compute the target volume size. The system where the target function is any one of: a simple decay function, a statistical function, and a linear function. The system where the memory contains further instructions that, when executed by the processing circuitry for determining the structure type of the cloud volume, further configure the system to: analyze structure information gathered during backup to determine filesystem options, management options, binary options, and boot options of the cloud volume. The system where the memory contains further instructions that, when executed by the processing circuitry for the structure type of the cloud volume is a binary volume, and further configure the system to: determine if the last blocks of the backup volume have been allocated; create the restored cloud volume; set of the restored cloud volume to a size set to the target volume size; and restore at a block-level all allocated blocks to the restored volume. The system where the memory contains further instructions that, when executed by the processing circuitry for the structure type of the cloud volume is an unbootable volume with a filesystem, and, further configure the system to: create the restored cloud volume; set of the restored volume to a size set to the target volume size; install a new filesystem on the restored volume, where a type of the new filesystem is a type of filesystem installed on the cloud volume; and restore files from the backup volume at a file-level to the new filesystem. The system where the memory contains further instructions which when executed by the processing circuitry further configure the system to: restore access control lists of the files restored to the new filesystem. The system where the memory contains further instructions that, when executed by the processing circuitry for the cloud volume is bootable, and, further configure the system to: create the restored volume as a bootable volume; set of the restored volume to a size set to the target volume size; install a new filesystem on the restored volume, where a type of the new filesystem is a type of filesystem installed on the cloud volume; restore boot data blocks at boot sectors of the restored volume; and restore files at the a file-level after restoring the boot data blocks, where the size of the restored files is less than the target volume size. The system where the memory contains further instructions that, when executed by the processing circuitry for the cloud volume is managed, and, further configure the system to: create a new restored volume based on a configuration retrieved from a volume manager; set of the restored volume to a size set to the target volume size; install a new filesystem on the restored volume, where a type of the new filesystem is a type of a filesystem installed on the cloud volume; and restore files from the backup volume at a file-level to the new filesystem. The system where the cloud volume, the backup volume, and the restored backup are deployed in one or more cloud computing platforms. Implementations of the described techniques may include hardware, a method or process, or a computer-tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

In the drawings:

FIG. 1 is an example network diagram illustrating a backup system for identifying and managing related storage volumes, in accordance with an embodiment of the present disclosure.

FIG. 2 is an example network diagram of backup system performing a database restoration, utilized to describe the disclosed embodiments.

FIG. 3 is a flowchart of an example process for resizing a cloud volume on a backup restore according to an embodiment.

FIG. 4 is a flowchart of an example process S for restoring the backup volume according to an embodiment.

FIG. 5 is a flowchart of an example process S for restoring the backup volume according to an embodiment.

FIG. 6 is a flowchart of an example process S for restoring the backup volume according to an embodiment.

FIG. 7 is a flowchart of an example process S for restoring the backup volume according to an embodiment.

FIG. 8 is an example schematic diagram of a backup system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments provide a system and method for resizing cloud volumes upon restoration of respective backup volumes. The cloud volumes are deployed in a cloud computing environment or multiple cloud computing environments. The resizing of a cloud volume to a size determined by actual data usage or storage within the cloud volume. The resizing techniques disclosed herein are of any type of cloud volume including, but not limited to, a volume managed by a volume manager, a bootable volume, a cloud volume by a file system, and the like.

The disclosed embodiments for resizing cloud volumes on restore include receiving a command to resize a cloud volume. The command is being received during a restore of the cloud volume backup and computing a target volume size for the cloud volume. In an embodiment, the target volume size is computed based on sizing information gathered over time during the backup. The disclosed embodiments further include determining a structure of the cloud volume and restoring the cloud volume to the computed target size based on the determined type.

The disclosed embodiments provide a number of technical improvements over solutions disclosed in the prior art. One technical improvement provided by the disclosed subject matter is the reduction in the cost of cloud storage, primarily due to the ability to restore cloud volumes to actual usage of storage.

Another technical improvement provided by the disclosed embodiments is the ability to maintain data integrity during the resizing process, ensuring that no data is lost. In contrast, currently available resizing methods are manual and prone to data loss when copying files from a cloud volume to a resized volume.

Another technical improvement provided by the disclosed embodiments is the ability to resize cloud volumes without any downtime. In contrast, current resizing processes are manual, and during the file transfer from one volume to a resized volume, the volumes are typically inaccessible.

Another technical improvement provided by the disclosed embodiments is a simple and straightforward resizing process. As noted above, current resizing methods are manual and involve many steps; as a result, a user cannot efficiently resize large numbers of volumes at scale.

In summary, the disclosed embodiments offer a simplified resizing process that reduces costs and ensures cloud volumes remain operational at all times with no data loss.

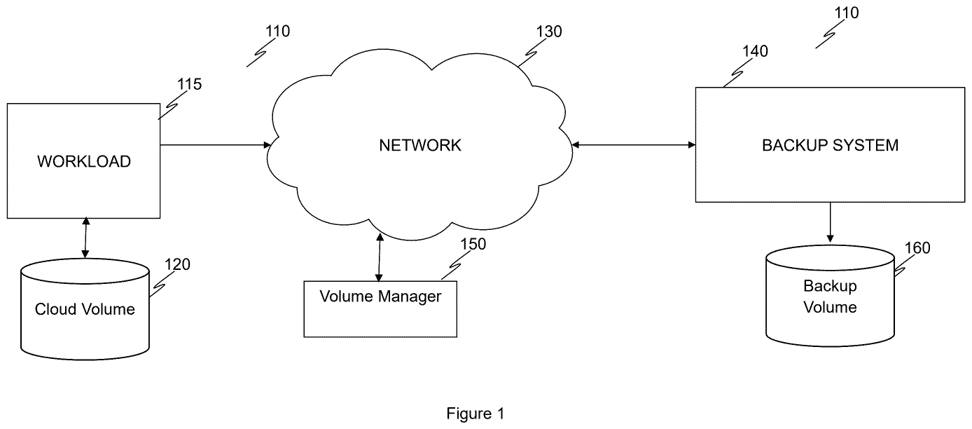

FIG. 1 is an example network diagram illustrating a backup system for identifying and managing related storage volumes, in accordance with an embodiment of the present disclosure. In embodiments, a computing environment 110 is configured to execute a workload 115 (e.g., a virtual machine (VM), a container, and the like), having an associated cloud volume 120. A cloud volume 120 is a type of block storage in cloud computing that acts like a virtual hard drive attached to a virtual machine (VM). A cloud volume provides persistent, high-performance storage for operating systems, applications, and data, just like physical disks on traditional servers but managed and scaled in the cloud. A cloud volume is a block storage resource that can store any kind of data, including binary data, just like a traditional disk. Examples for a cloud volume may include AWS® EBS, Azure® Disk, Google® Persistent Disk, and the like.

In some embodiments, cloud volume 120 can be a logical or physical block storage device attached to a workload 115. Cloud volume 120 may hold data in various file system formats, such as New Technology File System (NTFS), Fourth Extended File System (ext4), X File System (XFS), or partition schemes, such as Master Boot Record (MBR), and Globally Unique Identifier Partition Table (GPT). In an embodiment, cloud volume 120 may be a bootable volume. A bootable volume is a cloud storage volume that contains the operating system (OS) needed to boot a VM. A bootable volume is automatically mounted when a VM starts. Typically, a bootable volume is persistent (survives restarts), customizable (e.g., size, encryption), and detachable. Examples of a bootable volume include a root EBS volume in AWS EC2, an OS disk in Azure, and a boot persistent disk in GCP.

It should be appreciated that the contents of cloud volume 120 are dynamic and may change over time as data is written to, deleted from, or modified within the volume. Consequently, the size of cloud volume 120 may be adjusted in accordance with storage needs or system policies. For instance, cloud volume 120 may initially be provisioned with a capacity of 1 gigabyte (GB). However, the actual data stored within the volume at any given time may vary, such as ranging from approximately 200 megabytes (MB) to 250 MB during normal operation.

In another example, during a software update process, large temporary files may be written to cloud volume 120, causing a temporary spike in storage usage. After the update is complete and temporary files are deleted, the total storage usage may return to a lower steady state. These dynamic adjustments allow cloud volume 120 to be used more efficiently in environments where workloads are variable, such as data analytics applications or virtual machine storage.

In an embodiment, cloud volume 120 can be managed by a volume manager 160, such as an LVM. Volume manager 160 is a device mapper framework that provides logical volume management for operating systems, such as Linux. Volume manager 160 enables flexible disk management by abstracting physical storage devices and presenting them as logical volumes. i.e., cloud volumes.

In some embodiments, computing environment 110 hosting workload 115, cloud volume 120, and volume manager 160 can represent infrastructure, public cloud platforms (e.g., Amazon® Elastic Compute Cloud, Microsoft® Azure), containerized orchestration frameworks (e.g., Kubernetes®, Docker®), private cloud platforms, and hybrid cloud platforms. In some configurations, computing environment 110 can represent on-premises infrastructure.

In some embodiments, a network 130 provides connectivity between the computing environment(s) 110 and the backup system 140. Network 130 may include local area networks (LANs), wide area networks (WANs), or public cloud networks such as the Internet. Scanning and metadata retrieval processes can involve API calls or agent-based communications transmitted over network 130. Network 130 may also facilitate user interactions from remote devices or consoles that manage or configure backup settings.

Backup system 140 is configured to execute and orchestrate the processes of backing up cloud volume 120 into backup volume 150. To this aim, backup system 140 is configured to generate backup volume 150 by, for example, taking a storage-based snapshot of cloud volume 120, the snapshot to a second workload (not shown) in a backup environment, and generating backup volume 150 which includes binary data and the files of the file system as backup files. In one configuration, backup files can be stored as a column-oriented data file. A column-oriented data file is, for example, Apache® Parquet. The backup environment is where backup system 140 is deployed and can be within or outside the cloud environment 110. For example, a backup environment can be a separate tenant with the cloud environment 110 or in a different cloud platform.

Backup system 140 backs up cloud volume 120 at a predefined time interval, on-demand, or both. This creates multiple versions for backup volume 150, each version is associated with a specific point in time. In an embodiment, backup system 140 collects or logs sizing information on cloud volume 120. To this aim, for each version of backup volume 150, backup system 140 logs a current size of the backup volume (corresponding to cloud volume) for a current version and time of backup. Alternatively or collectively, the sizing information can be determined based on statistics of the cloud volume's 120 activity. Such information is collected by backup system 140 from the cloud infrastructure. The sizing information can be stored in the backup volume's 150 metadata. For example, Table 1 shows a log of different cloud backup versions and their respective actual size and times of backup.

TABLE 1

| Version No. | Time | Actual Backup Size |
|---|---|---|
| 1.001 | 01/02/2024 01:30 | 200 GB |
| 1.002 | 02/02/2024 01:30 | 225 GB |
| 1.003 | 03/02/2024 01:30 | 250 GB |

In the example shown in Table 1, the actual backup size corresponds to the size of the actual usage of storage in cloud volume 120. Here, the size increases by 25 GB once a month.

Another example is shown in Table 2:

TABLE 2

| Version No. | Time | Actual Backup Size |
|---|---|---|
| 2.001 | 01/02/2024 01:30 | 500 GB |
| 2.002 | 02/02/2024 01:30 | 375 GB |
| 2.003 | 03/02/2024 01:30 | 250GB |

In the example shown in Table 2, the actual backup size corresponds to the size of the actual usage of storage in cloud volume 120. Here, the size decreases over time.

In an embodiment, maintaining the log of the actual volume size allows resizing the cloud volume upon restoration. That is, when backup volume is restored, the size of a restored volume will be determined based on the sizing information not the original cloud volume's size. Resizing a volume includes a shrinking operation or an expansion operation. The various embodiments for restoring and resizing backup volume 150 are discussed below.

As an example, a storage size allocated to cloud volume 120 is 300 GB. Based on Table 1, the total amount of data in the volume's size increased over 3 months from 200 GB to 250 GB. Therefore, on the resort, the backup cloud can be expanded to more than 300 GB. As another example, a storage size allocated to cloud volume 120 is 1 TB. Based on Table 2, the total amount of data in the volume's size decreased over 3 months from 500 GB to 250 GB. Therefore, on the resort, backup cloud 150 can be shrunk to less than 1 TB. As will be discussed below, a target volume size can be determined, and the size of the restored volume will be set to the target volume size.

According to an embodiment, backup system 140 is configured to communicate with workload 115, volume manager 160, and/or cloud orchestrator (not shown) in order to gather structure information indicative of the structure type of the cloud volume. The volume's structure type may be stored in the backup volume's 150 metadata.

To this end, in an embodiment, backup system 140 may request and retrieve metadata identifiers for cloud volume 120. The retrieved metadata may include the filesystem type (e.g., ext4, NTFS, or XFS), partition layout (e.g., MBR, GPT), a boot options with the volume (i.e., bootable or not), management option for the volume (managed by LVM or not), and/or other descriptive parameters (e.g., volume labels, timestamps). In some embodiments, agents installed in the cloud computing environment(s) may communicate directly with backup system 140, providing a range of metadata identifiers related to the structure type of cloud volume 120. The structure information of the cloud volume is stored in the backup volume's 150 metadata.

It should be noted that backup system 140 can generate machine backup of workload 115, where the machine backup can be either a machine backup or a file-level backup. Further, backup system 140 can generate an application backup, such as a database application hosted on workload 115. For example, such a database application is implemented as a managed database, for example, Amazon® RDS. Various embodiments for allowing the backup system 140 are discussed in U.S. patent application Ser. No. 18/940,434 filed on Nov. 7, 2024, assigned to a common assignee and hereby incorporated by reference for that it contains.

It should be understood that the embodiments described herein are not limited to the specific arrangement illustrated in FIG. 1. Rather, the principles and techniques disclosed are applicable to implementations involving multiple cloud volumes and backup volumes, which may reside within a single cloud computing platform or be distributed across multiple cloud computing environments. Each such volume may be independently managed, accessed, and scaled, and the described functionality may operate across heterogeneous infrastructure, including public, private, and hybrid cloud deployments. Accordingly, the scope of the present disclosure extends to a variety of cloud storage topologies and configurations beyond those explicitly depicted.

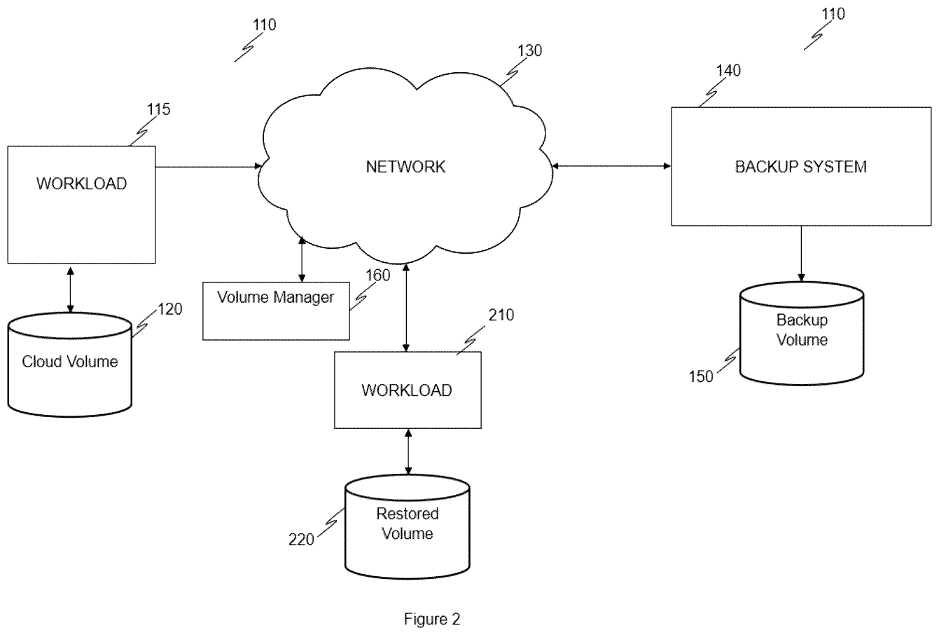

FIG. 2 is an example network diagram of backup system 140 performing a database restoration, utilized to describe the disclosed embodiments. In some embodiments, the backup system 140 is configured to restore a volume based on a file-level backup, a block-level backup, and system-level backup depending on the structure of cloud volume 120.

According to an embodiment, backup system 140 is configured to receive a request to restore backup volume 150. The restore command may include a request to resize the backup volume when restored.

First, backup system 140 instructs an orchestrator (not shown), other provisioning device, and the like, to deploy a restored workload 210, which corresponds to the workload 115. For example, in an embodiment, the restored workload is deployed from an auto-scaling group (ASG), which is deployed in a VPC of a cloud computing environment.

To restore the backup volume 150, backup system 140 computes a target volume size for a restored volume 220. Volume 220 is restored from backup volume 150, which corresponds to cloud volume 120. It should be noted that the contents of the restored volume 220 are the same as the cloud volume 120, but may be created with a different size.

Prior to restoring volume 150, backup system 140 determines or computes a target volume size for volume 220 based on the sizing information gathered during the backup and determines a structure type of cloud volume 120. The structure type of a volume structure may include a binary volume without a filesystem, a bootable volume, or an unbootable volume installed with a filesystem. In an embodiment, the sizing information and the structure type of cloud volume 120 are retrieved from the backup's metadata.

Backup system 140 restores backup volume 150 based on the computed target volume size and the determined structure. In one embodiment, when the structure of backup volume 150 is the binary volume, backup system 140 determines if the last blocks of the backup volume have been allocated. If so, a new volume is created as a restored volume 220 with a size set to be the target volume size. Then, all allocated blocks from backup volume 150 are copied to the restored volume 200.

In another embodiment, when the structure of backup volume 150 is the unbootable volume with a filesystem, backup system 140 restores the backup volume 150 at a file-level. To this end, backup system 140 creates a restored volume 220 installed with a filesystem and restores the files from backup volume 150 at file-level to the newly created filesystem. The size of the restored volume 120 is set to the target volume size. In one configuration, backup system 140 also restores the access control lists of the files being restored.

Restoring at the file-level may include retrieving and copying specific files or folders from the backup volume 150 to the restored volume 220, using backup system 140. This process allows you to recover individual pieces of data without affecting the workload 115, thus without any downtime.

In yet another embodiment, when cloud volume 120 is bootable, backup system 140 creates a new restored volume 220, as a bootable volume with boot sectors. In an embodiment, a bootable volume is implemented utilizing Amazon® Elastic Block Storage (EBS). Then, backup system 140 updates the boot sectors, restores boot data blocks at the boot sectors, creates in the restored volume 220 a new filesystem, and restores files at a file-level after restoring the boot data blocks at a block-level. The size of the restored volume 220 is set to the target volume size.

Restoring at a block-level may include restoring data at the level of raw storage blocks rather than individual files or folders. The process reconstructs restored volume 220 by writing the exact data blocks back to a disk of restored volume 220, thereby essentially recreating the entire structure of the original cloud volume 120, including the operating system, applications, configuration, and files.

In yet another embodiment, when cloud volume 120 is managed by the volume manager 160, the backup system 140 restores the backup volume 150 based on configuration retrieved from the volume manager 160. To this end, backup system 140 creates a new restored volume 220 based on the configuration retrieved from volume manager 160, installs a new filesystem in the restored volume 220, and restores files at a file-level to the new filesystem. The size of the restored volume 220 is set to the target volume size.

In all of the above embodiments, the filesystem of the restored volume 220 is determined based on the file system type installed in cloud volume 120. The file system type may include, for example, ext4, NTFS, XFS, and the like.

It should be understood that the embodiments described herein are not limited to the specific arrangement illustrated in FIG. 2. Rather, the principles and techniques disclosed are applicable to implementations involving multiple cloud volumes, multiple backup volumes, and/or multiple restored volumes which may reside within a single cloud computing platform or be distributed across multiple cloud computing environments. Each of such volumes may be independently managed, accessed, and scaled, and the described functionality may operate across heterogeneous infrastructure, including public, private, and hybrid cloud deployments. Accordingly, the scope of the present disclosure extends to a variety of cloud storage topologies and configurations beyond those explicitly depicted.

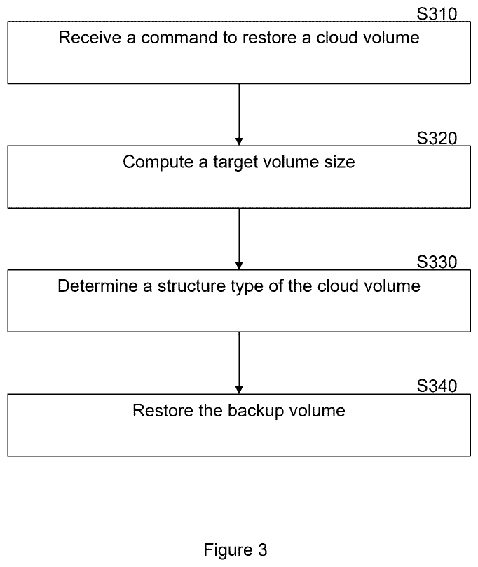

FIG. 3 is a flowchart of an example process for resizing a cloud volume on a backup restore according to an embodiment. In some implementations, one or more process blocks of FIG. 3 may be performed by the backup system 140.

At S310, a command to restore a cloud volume is received. The command is being received during a restore of the backup volume, where the backup volume provides a backup of the cloud volume.

At S320, a target volume size for the cloud volume is computed. In an embodiment, the target volume size is computed based on sizing information gathered over time during the backup of the cloud volume. Such sizing information is maintained in the backup volume's metadata.

In an embodiment, a target function is applied to the sizing information to compute a target volume size. As an example, the target function may be a simple decay function:

S(target)=Sn+ΔS*∝

Where Sₙ is the last size of the volume, ΔS and is the difference in storage sizes, and ∝ is a preconfigured factor (e.g., between 0 and 1). As an example, applying the decay function on the sizing information shown in Table 2 would result:

S(target)=250+125*0.5=325 GB

And the target volume size is: 325 GB. Here, ∝=0.5, and ΔS=125.

As another example, the target function may be a linear function:

S(t)=S(0)+ΔS*t

Where S(t) is the storage in GB at a time t, S(0) is the initial size of the cloud volume, and time-interval change is ΔS. As an example, applying the linear function on the values shown in Table 2 would result in a target volume size of:

S(4)=25·4+200=100+200=300 GB

In this example, the time interval is a month. In this example, the estimated required size is in the 4^{th} month. However, the volume can be resized to an estimated required size for any future time, e.g., 6 months, a year, 18 months, etc.

Other examples of a target function may include statistical functions, such as average, mean, and the like. The target function may also include increasing or decreasing an absolute number from the recent size of the cloud volume. It should be noted that the disclosed embodiments are not limited to the target functions discussed herein.

At S330, a structure type of the cloud volume is determined. This includes analyzing structure information maintained in the backup volume's metadata to determine at least filesystem options, management options, binary options, and boot options of the cloud volume. Filesystem options include whether the cloud volume is installed with a filesystem, and if so, the type of the filesystem. Management options include whether the cloud volume is managed by a volume manager (e.g., LVM) or not. Binary options include whether the cloud volume includes binary data (i.e., a binary volume) or not. Boot options of the cloud volume include whether the cloud volume is bootable or not. The structure type may be determined as a combination of these options, e.g., bootable volume with a filesystem.

At S340, the backup volume is restored to a restored volume based on the target volume size and the determined structure type. In an embodiment, S340 includes instructing an orchestrator, other provisioning device, and the like, to deploy a restored workload, which corresponds to the workload hosted the cloud volume.

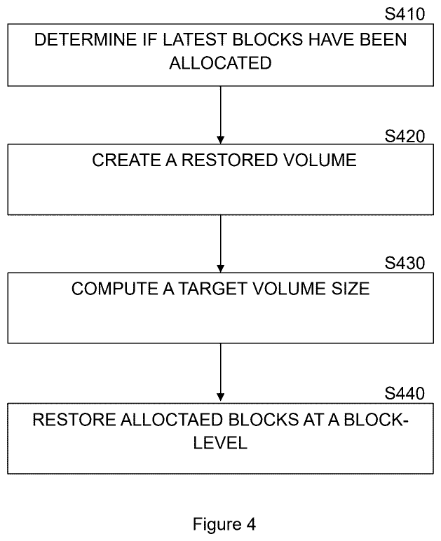

The disclosed embodiments provide different processes for carrying out S340. These processes are discussed in greater detail in FIGS. 4-7.

Although FIG. 3 shows example blocks of process, in some implementations, process may include additional blocks, fewer blocks, different blocks, or differently arranged blocks than those depicted in FIG. 3. Additionally, or alternatively, two or more of the blocks of process may be performed in parallel.

FIG. 4 is a flowchart of an example process S340 for restoring the backup volume according to an embodiment. In some implementations, one or more process blocks of FIG. 4 may be performed by the backup system 140. The process shown in FIG. 4 is performed when the structure type of the cloud volume is a binary volume.

At S410, it is determined if the last blocks of the backup volume are unallocated. If so, at S420, a restored volume is created. The restore allows resizing up to the last allocated block with additional storage that can be computed based on the decay function above. restored. Note, a restore can be performed only if S410 is determined to be true.

In an embodiment, S410 includes checking the data structure used to track block usage. Such structure is maintained by a backup volume filesystem as well. For example, the ex4 filesystem uses a block bitmap to map blocks that have been accessed.

In embodiment, creating a restored volume, at S420, involves provisioning a block storage resource in a cloud environment that can be attached to the restored workload or used for persistent storage. Each cloud provider has its own process and terminology, but the core steps are generally similar across platforms. For example, EBS Volume in AWS is created using a CLI “aws ec2 create-volume” or by AWS APIs.

At S430, the size of the restored volume is set to the computed target volume size. In an embodiment, the target volume size is different than the size of the cloud volume as initially created. As such, S430, by setting the restored volume to the target volume size, the cloud volume is either shrunk or expanded on a restore. In an embodiment, S430 includes setting an encryption level for the restored volume, region, or any other parameters. S430 can be performed as part of the CLI to create the restored volume.

At S440, all allocated blocks are restored at a block-level to the restored volume. A block-level restore rebuilds an entire volume by copying data, specifically binary data at the raw storage block level, allowing for a complete recovery of the operating system, applications, and files. The binary data, as stored in the backup volume, may include executable files, image files, databases, system files, and the like.

Although FIG. 4 shows example blocks of process S340, in some implementations, process S340 may include additional blocks, fewer blocks, different blocks, or differently arranged blocks than those depicted in FIG. 4. Additionally, or alternatively, two or more of the blocks of process S340 may be performed in parallel.

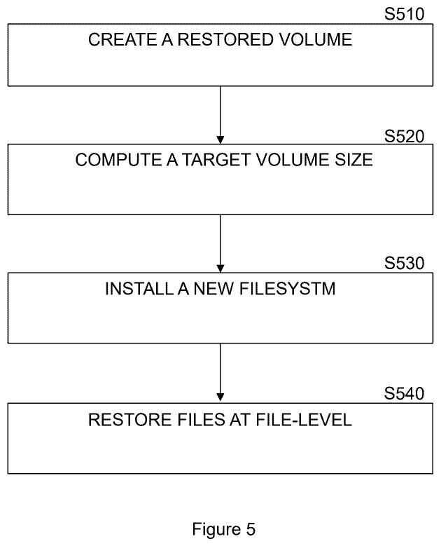

FIG. 5 is a flowchart of an example process S340 for restoring the backup volume according to an embodiment. In some implementations, one or more process blocks of FIG. 5 may be performed by the backup system 140. The process shown in FIG. 5 is performed when the structure type of the cloud volume is installed with a filesystem and is not bootable.

At S510, a restored volume is created. In embodiment, S510 involves provisioning a block storage resource in a cloud environment that can be attached to the restored workload or used for persistent storage. Each cloud provider has its own process and terminology, but the core steps are generally similar across platforms. For example, EBS Volume in AWS is created using a CLI “aws ec2 create-volume” or using AWS APIs.

At S520, the size of the restored volume is set to the computed target volume size. In an embodiment, the target volume size is different than the size of the cloud volume as initially created. As such, S520, by setting the restored volume to the target volume size, the cloud volume is either shrunk or expanded on a restore. In an embodiment, S520 includes setting an encryption level for the restored volume, region, or any other parameters. S520 can be performed as part of the CLI to create the restored volume.

At S530, a new filesystem is installed on the restored volume. In an embodiment, a type of the new filesystem is a type of filesystem installed on the cloud volume. For example, a filesystem may include ex4, NTFS, XTS, and the like.

At S540, files from the backup volume are restored at a file-level to the new filesystem. A file-level restore may include retrieving and copying specific files or folders from the backup volume to the restored volume's file system. In some embodiments, file system files, application files, configuration files, and the like, stored in the backup volume are copied into the restored volume. In an embodiment, S540 includes restoring access control lists of the files restored to the new filesystem.

Although FIG. 5 shows example blocks of process S340, in some implementations, process S340 may include additional blocks, fewer blocks, different blocks, or differently arranged blocks than those depicted in FIG. 5. Additionally, or alternatively, two or more of the blocks of process S340 may be performed in parallel.

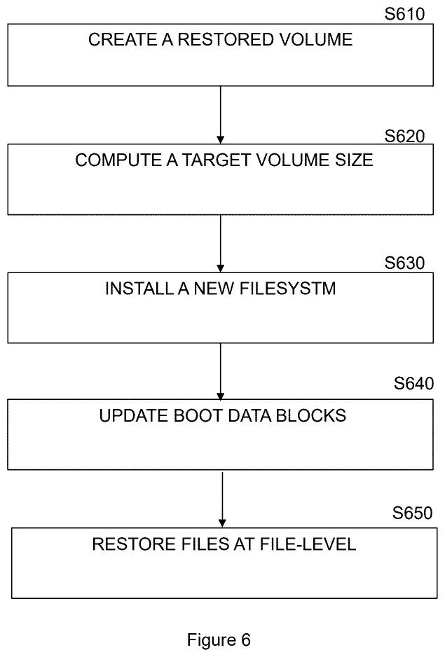

FIG. 6 is a flowchart of an example process S340 for restoring the backup volume according to an embodiment. In some implementations, one or more process blocks of FIG. 5 may be performed by the backup system 140. The process shown in FIG. 6 is performed when the structure type of the cloud volume is a bootable volume.

At S610, a restored volume is created as a bootable volume. In an embodiment, the bootable volume is generated in a cloud computing environment. For example, in an embodiment, a bootable volume is a Microsoft® Azure Managed Disk, a GCP Persistent Disk, an AWS EBS, and the like. In an embodiment, the bootable volume is an empty bootable machine volume, which includes only, for example, an operating system and configuration files that are required to boot a virtual machine, compute instance, and the like.

At S620, the size of the restored volume is set to the target volume size. In an embodiment, the target volume size is different than the size of the cloud volume as initially created. As such, S620, by setting the restored volume to the target volume size, the cloud volume is either shrunk or expanded on a restore. In an embodiment, S620 includes setting an encryption level for the restored volume, region, or any other parameters. S620 can be performed as part of the CLI to create the restored volume.

At S630, a new filesystem is installed on the restored volume. In an embodiment, a type of the new filesystem is a type of filesystem installed on the cloud volume. For example, a filesystem may include ex4, NTFS, XTS, and the like.

At S640, boot data blocks are copied from the backup volume to boot sectors of the restored volume and updated correctly to allow boot. In an embodiment, S640 can be performed using a block-level restored.

At S650, files from the backup volume are restored at a file-level to the new filesystem of the restored volume. A file-level restore may include retrieving and copying specific files or folders from the backup volume to the restored volume's filesystem. In some embodiments, filesystem files, application files, configuration files, and the like, stored in the backup volume are copied into the restored (bootable) volume.

Although FIG. 6 shows example blocks of process S340, in some implementations, process S340 may include additional blocks, fewer blocks, different blocks, or differently arranged blocks than those depicted in FIG. 6. Additionally, or alternatively, two or more of the blocks of process S340 may be performed in parallel.

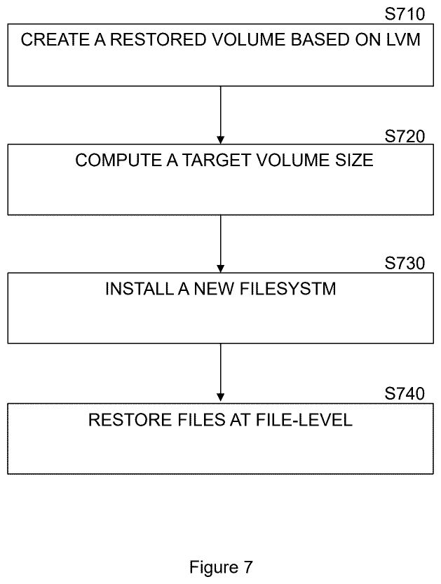

FIG. 7 is a flowchart of an example process S340 for restoring the backup volume according to an embodiment. In some implementations, one or more process blocks of FIG. 7 may be performed by the backup system 140. The process shown in FIG. 7 is performed when the structure type of the cloud volume is a managed volume.

At S710, a restored volume is created based on provisioning data retrieved from a volume manager. In embodiment, S710 involves querying or retrieving provisioning data from a volume manager, such as LVM. The provisioning data may include detailed information about disks (PVs), volume groups (VGs), logical volumes (LVs), and snapshots, including sizes, usage, relationships, and allocation details. Such provisioning data can be retrieved during backup or during the restore process by querying or pulling such data from the volume manager.

At S720, the size of the restored volume is set to the computed target volume size. In an embodiment, the target volume size is different than the size of the cloud volume as initially created. As such, S720, by setting the restored volume to the target volume size, the cloud volume is either shrunk or expanded on a restore. In an embodiment, S720 includes setting an encryption level for the restored volume, region, or any other parameters. S720 can be performed as part of the CLI to create the restored volume.

At S730, a new filesystem is installed on the restored volume. In an embodiment, a type of the new filesystem is a type of filesystem installed on the cloud volume. For example, a filesystem may include ex4, NTFS, XTS, and the like.

At S740, files from the backup volume are restored at a file-level to the new filesystem. A file-level restore may include retrieving and copying specific files or folders from the backup volume to the restored volume's filesystem. In some embodiments, file system files, application files, configuration files, and the like, stored in the backup volume are copied into the restored volume. In an embodiment, S740 includes restoring access control lists of the files restored to the new filesystem.

Although FIG. 7 shows example blocks of process S340, in some implementations, process S340 may include additional blocks, fewer blocks, different blocks, or differently arranged blocks than those depicted in FIG. 7. Additionally, or alternatively, two or more of the blocks of process S340 may be performed in parallel.

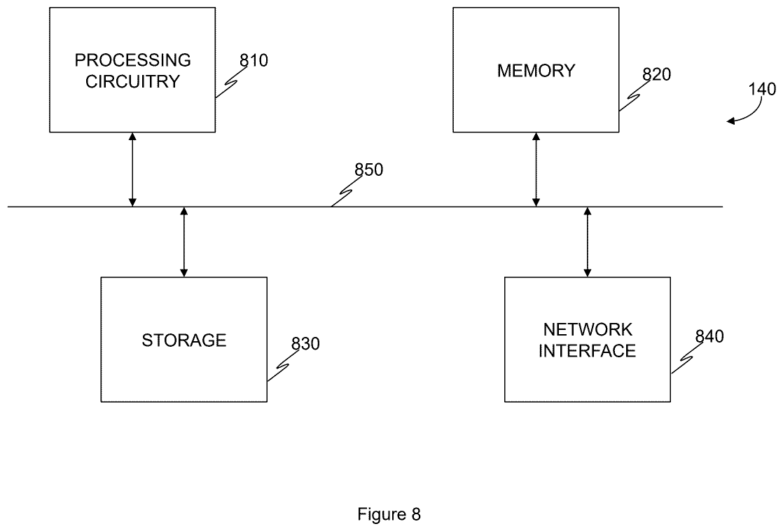

FIG. 8 is an example schematic diagram of a backup system 140 according to an embodiment. The backup system 140 includes, according to an embodiment, processing circuitry 810 coupled to a memory 820, a storage 830, and a network interface 840. In an embodiment, the components of the backup system 140 are communicatively connected via a bus 850.

In certain embodiments, the processing circuitry 810 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information. In some embodiments, the processing circuitry 810 executes instructions related to discovering storage volumes, analyzing metadata (e.g., filesystem UUIDs, partition GUIDs), identifying volume lineage, and providing backup management capabilities as disclosed herein.

In an embodiment, the memory 820 is a volatile memory (e.g., random access memory), a non-volatile memory (e.g., flash memory), or a combination thereof. In some embodiments, the memory 820 is an on-chip memory, an off-chip memory, or any combination thereof. The memory 820 may store data structures (e.g., volume metadata tables, lineage graphs) or program instructions enabling the backup system 140 to scan multiple computing environments, perform lineage detection, and carry out other processes described in this disclosure.

In one configuration, software for implementing one or more embodiments disclosed herein is stored in the storage 830, in the memory 820, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). When executed by the processing circuitry 810, these instructions cause the backup system 140 to perform various processes described herein, such as retrieving volume data, comparing metadata identifiers, identifying orphaned volumes, and providing deduplication or remediation options.

In some embodiments, the storage 830 is a magnetic storage, an optical storage, a solid-state storage, or a combination thereof, realized, for example, as a flash memory or a hard disk drive. The storage 830 may hold backup files, snapshots, metadata identifying shared or duplicate volumes, and other relevant information needed for volume lineage detection and resource optimization. By maintaining such data, the backup system 140 can correlate multiple volumes across different environments and highlight their lineage relationships or orphaned status.

The network interface 840 is configured to provide the backup system 140 with communication to, for example, a cloud provider, one or more computing environments (such as virtual machines or containers), or other external services. In some embodiments, the network interface 840 enables the system to initiate scans of storage volumes, retrieve or update metadata, and communicate with administrative consoles or policy engines responsible for evaluating redundant or orphaned volumes.

It should be understood that the embodiments described herein are not limited to the specific architecture illustrated in FIG. 8, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for resizing cloud volumes on a backup restore, comprising:
receiving a command to restore a cloud volume, the command is being received during a restore of the backup volume, wherein backup volume provides a backup of the cloud volume;
computing a target volume size for a restored cloud volume, wherein the target volume size is computed based on sizing information gathered over time during the backup of the cloud volume;
determining a structure type of the cloud volume; and
restoring the backup volume to the restored cloud volume based on the target volume size and the determined structure type, wherein the restored cloud volume contains same files and structure as the cloud volume, and wherein a size of the cloud restored volume is different than a size of the cloud volume as originally created.

2. The method of claim 1, wherein computing the target volume size further comprising:
retrieving the sizing information from a metadata of the backup volume; and
applying a target function on the sizing information to compute the target volume size.

3. The method of claim 2, wherein the target function is any one of: a simple decay function, a statistical function, and a linear function.

4. The method of claim 1, wherein determining the structure type of the cloud volume further comprises:
analyzing structure information gathered during backup to determine filesystem options, management options, binary options, and boot options of the cloud volume.

5. The method of claim 1, wherein the structure type of the cloud volume is a binary volume, and wherein restoring the backup volume further comprises:
determining if the last blocks of the backup volume have been allocated;
creating the restored cloud volume;
setting of the restored cloud volume to a size set to the target volume size; and
restoring at a block-level all allocated blocks to the restored volume.

6. The method of claim 1, wherein the structure type of the cloud volume is an unbootable volume with a filesystem, and wherein restoring the backup volume further comprises:
creating the restored cloud volume;
setting of the restored volume to a size set to the target volume size;
installing a new filesystem on the restored volume, wherein a type of the new filesystem is a type of filesystem installed on the cloud volume; and
restoring files from the backup volume at a file-level to the new filesystem.

7. The method of claim 6, further comprising:
restoring access control lists of the files restored to the new filesystem.

8. The method of claim 1, wherein the cloud volume is bootable, and wherein restoring the backup volume further comprises:
creating the restored volume as a bootable volume;
setting of the restored volume to a size set to the target volume size;
installing a new filesystem on the restored volume, wherein a type of the new filesystem is a type of filesystem installed on the cloud volume;
restoring boot data blocks at boot sectors of the restored volume; and
restoring files at a file-level after restoring the boot data blocks, wherein the size of the restored files is less than the target volume size.

9. The method of claim 1, wherein the cloud volume is managed, and wherein restoring the cloud volume further comprises:
creating a new restored volume based on a configuration retrieved from a volume manager;
setting of the restored volume to a size set to the target volume size;
installing a new filesystem on the restored volume, wherein a type of the new filesystem is a type of a filesystem installed on the cloud volume; and
restoring files from the backup volume at a file-level to the new filesystem.

10. The method of claim 1, wherein the cloud volume, the backup volume, and the restored backup are deployed in one or more cloud computing platforms.

11. A non-transitory computer-readable medium storing a set of instructions for resizing cloud volumes on a backup restore, the set of instructions comprising:
one or more instructions that, when executed by one or more processors of a device, cause the device to:
receive a command to restore a cloud volume, the command is being received during a restore of the backup volume, wherein backup volume provides a backup of the cloud volume;
compute a target volume size for a restored cloud volume, wherein the target volume size is computed based on sizing information gathered over time during the backup of the cloud volume;
determine a structure type of the cloud volume; and
restore the backup volume to the restored cloud volume based on the target volume size and the determined structure type, wherein the restored cloud volume contains same files and structure as the cloud volume, and wherein a size of the cloud restored volume is different than a size of the cloud volume as originally created.

12. A system for resizing cloud volumes on a backup restore comprising:
a processing circuitry;
a memory, the memory containing instructions that, when executed by the processing circuitry, configure the system to:
receive a command to restore a cloud volume, the command is being received during a restore of the backup volume, wherein backup volume provides a backup of the cloud volume;
compute a target volume size for a restored cloud volume, wherein the target volume size is computed based on sizing information gathered over time during the backup of the cloud volume;
determine a structure type of the cloud volume; and
restore the backup volume to the restored cloud volume based on the target volume size and the determined structure type, wherein the restored cloud volume contains same files and structure as the cloud volume, and wherein a size of the cloud restored volume is different than a size of the cloud volume as originally created.

13. The system of claim 12, wherein the memory contains further instructions that, when executed by the processing circuitry for computing the target volume size, further configure the system to:
retrieve the sizing information from a metadata of the backup volume; and
apply a target function on the sizing information to compute the target volume size.

14. The system of claim 13, wherein the target function is any one of: a simple decay function, a statistical function, and a linear function.

15. The system of claim 12, wherein the memory contains further instructions that, when executed by the processing circuitry for determining the structure type of the cloud volume, further configure the system to:
analyze structure information gathered during backup to determine filesystem options, management options, binary options, and boot options of the cloud volume.

16. The system of claim 12, wherein the memory contains further instructions that, when executed by the processing circuitry for the structure type of the cloud volume is a binary volume, and further configure the system to:
determine if the last blocks of the backup volume have been allocated;
create the restored cloud volume;
set of the restored cloud volume to a size set to the target volume size; and
restore at a block-level all allocated blocks to the restored volume.

17. The system of claim 12, wherein the memory contains further instructions that, when executed by the processing circuitry for the structure type of the cloud volume is an unbootable volume with a filesystem, and further configure the system to:
create the restored cloud volume;
set of the restored volume to a size set to the target volume size;
install a new filesystem on the restored volume, wherein a type of the new filesystem is a type of filesystem installed on the cloud volume; and
restore files from the backup volume at a file-level to the new filesystem.

18. The system of claim 17, wherein the memory contains further instructions which when executed by the processing circuitry further configure the system to:
restore access control lists of the files restored to the new filesystem.

19. The system of claim 12, wherein the memory contains further instructions that, when executed by the processing circuitry for the cloud volume is bootable, and further configure the system to:
create the restored volume as a bootable volume;
set of the restored volume to a size set to the target volume size;
install a new filesystem on the restored volume, wherein a type of the new filesystem is a type of filesystem installed on the cloud volume;
restore boot data blocks at boot sectors of the restored volume; and
restore files at a file-level after restoring the boot data blocks, wherein the size of the restored files is less than the target volume size.

20. The system of claim 12, wherein the memory contains further instructions that, when executed by the processing circuitry for the cloud volume is managed, and further configure the system to:
create a new restored volume based on a configuration retrieved from a volume manager;
set of the restored volume to a size set to the target volume size;
install a new filesystem on the restored volume, wherein a type of the new filesystem is a type of a filesystem installed on the cloud volume; and
restore files from the backup volume at a file-level to the new filesystem.

21. The system of claim 12, wherein the cloud volume, the backup volume, and the restored backup are deployed in one or more cloud computing platforms.
